(19) United States
(12) Patent Application Publication
(10) Pub. No.: US 2018/0044968 A1
(43) Pub. Date: Feb. 15, 2018

(54) WINDOW REGULATOR FOR VEHICLE

(71) Applicant: SHIROKI CORPORATION, Fujisawa-shi, Kanagawa (JP)

(72) Inventors: Atsushi MURAMATSU, Fujisawa-shi, Kanagawa (JP); Kenji YAMAMOTO, Fujisawa-shi, Kanagawa (JP)

(73) Assignee: SHIROKI CORPORATION, Fujisawa-shi, Kanagawa (JP)

(21) Appl. No.: 15/554,758

(22) PCT Filed: May 27, 2016
(86) PCT No.: PCT/JP2016/065668

§ 371 Date: Aug. 31, 2017

(30) Foreign Application Priority Data
May 29, 2015 (JP) 2015-109400

(51) Int. Cl. E05F 15/689; B60J 5/04; E05D 15/16; B60J 1/17

(52) U.S. Cl. CPC E05F 15/689; B60J 1/17; B60J 5/0416; E05D 15/165; E05Y 2201/654; E05Y 2201/708; E05Y 2900/55

(57) ABSTRACT

A vehicle window regulator includes a slider base supported on a guide rail; a drive wire connected to the slider base; a wire guide supported at one end of the guide rail and having a winding part, onto which the drive wire is wound, at a position offset from the guide rail in a vehicle width direction; and a driver which raises and lowers the slider base via the drive wire. The wire guide is supported by the guide rail by a retainer and a pressing portion, the retainer engaged with the guide rail, and the pressing portion being engaged with the guide rail to press the guide rail toward the other end of the guide rail. The pressing portion is formed at a position toward the other end and formed at a position offset from the retainer toward the winding part.

### TECHNICAL FIELD

The present invention relates to a window regulator configured to raise and lower a window glass of a vehicle.

### BACKGROUND ART

A regulator is known in the art having a guide rail extending in an upward and downward direction; a slider base supported on the guide rail in a manner to be raisable and lowerable therealong, a window glass being mounted onto the slider base; a pair of drive wires that extend upwardly and downwardly from the slider base; a pair of upper and lower wire-guide members configured to guide the pair of drive wires; and a driver (drive motor) configured to drive the pair of drive wires, which are guided by the upper and lower wire-guide members (Patent Literature 1).

In such a type of window regulator, at least one of the upper and lower wire-guide members is supported by the guide rail, and this guide rail, due to space problems within the door, is mounted to a door panel (inner door panel) via mounting brackets (panel mounts) at positions (at inner positions from respective wire guide members along the extending direction of the guide rail) away from upper and lower end-portions of the guide rail (the upper and lower end-portions of the guide rail cannot be mounted onto the door panel).

### CITATION LIST

### Patent Literature

[Patent Literature 1] Japanese Unexamined Patent Publication No. 2012-246671

### SUMMARY OF INVENTION

### Technical Problem

Due to the demand for lighter-weight vehicles, there is also a demand for lighter-weight window regulators. Reducing the thickness of the metal sheet that configures the guide rail has been studied as one idea for achieving a lighter weight. However, if the thickness of the guide rail is reduced, a new problem occurs with the guide rail deforming.

In other words, due to the raising and lowering of the window glass, tension is applied to the end-portions of the guide rail via the drive wires and the wide-guide members. On the other hand, since the mounting positions of the guide rail onto the door panel are at inner positions from respective wire guide members along the extending direction of the guide rail (for example, a downward position from upper wire-guide member in the case of the upper wire-guide member), there is a possibility of the guide rail deforming upwardly and downwardly from the door panel mounting position. This deformation occurs in the vehicle width direction about the door panel mounting position(s), and is tentatively termed as “bowing deformation”. In addition to thickness reduction, in order to arrange the wire-guide members and the drive wires, the end portions of the guide rail are cut out, thereby changing the sectional shape of the guide rail (reducing the section coefficients), an increase in the torque of the drive motor also becomes a cause of “bowing deformation”.

Accordingly, it is an object of the present invention to achieve a window regulator in which “bowing deformation” of the guide rail does not easily occur even if a reduction in thickness of the guide rail or a change in profile of the cross-section thereof occurs.

### Solution to Problem

The present invention a window regulator is provided, including a guide rail extending in an upward and downward direction; a slider base supported on the guide rail in a manner to be raisable and lowerable therealong, a window glass being mounted onto the slider base; a drive wire connected to the slider base; a wire guide supported at one end portion of the guide rail, the wire guide having a winding part, onto which the drive wire is wound at a position offset from the guide rail in a vehicle width direction; and a driver configured to raise and lower the slider base via the drive wire. The wire guide is supported by the guide rail by at least a retainer and a pressing portion, the retainer being engaged with the guide rail to prevent the wire guide from moving away from the guide rail in the vehicle width direction, and the pressing portion being engaged with the guide rail so as to press the guide rail toward the other end of the guide rail. The pressing portion is formed at a position toward the other end relative to the retainer, and formed at a position that is offset from the retainer in a vehicle width direction toward the winding part.

In an embodiment, the pressing portion is positioned on a plane of movement in which the drive wire, which moves in accordance with the wire guide, or the pressing portion is positioned from the plane away from the retainer.

It is desirable for the pressing portion to overlap with part of a panel mount, with respect to the upward and downward direction, when viewed in a vehicle forward and rearward direction, the panel mount configured to mount the guide rail to a door panel.

In an embodiment, the wire guide includes a pulley bracket; and a pulley, onto which the drive wire is wound, the pulley being rotatably supported by the pulley bracket. The retainer includes a pulley axle which supports the pulley and the pulley bracket onto the guide rail. The pressing portion is formed on the pulley bracket.

It is desirable for the pressing portion to be connected to the pulley bracket, wherein the pulley bracket is positioned to sandwich the pulley, in the vehicle width direction, by the retainer, the pulley bracket includes a pulley-axle supporter with which the pulley axle engages, and the pulley axle presses the pulley-axle supporter toward the other end.

It is practical for one of the pressing portions to be a projection and for the other of the pressing portions to be a hole, into which said projection engages.

### Advantageous Effects of Invention

According to the present invention, a window regulator can be achieved in which “bowing deformation” of the guide rail does not easily occur even if a reduction in thickness of the guide rail or a change in profile of the cross-section thereof occurs.

### BRIEF DESCRIPTION OF DRAWINGS

FIG. 1 is a front elevational view of a window regulator, to which the present invention is applied.

FIG. 2 is a rear elevational view of the window regulator.

FIG. 3 is side elevational view of the window regulator.

FIG. 4. is an enlarged view of the IV section in FIG. 2.

FIG. 5 is an enlarged view of the V section in FIG. 3.

FIG. 6 is cross-sectional view taken along the VI-VI line in FIG. 4.

FIG. 7 is a cross-sectional view taken along the VII-VII line in FIG. 4.

FIG. 8 is a cross-sectional view taken along the VIII-VIII line in FIG. 4.

FIG. 9 is a cross-sectional view taken along the IX-IX line in FIG. 4.

FIG. 10 is an exploded perspective view showing a guide rail and a wire-guide member, to be mounted to the guide rail, in a state before being mounted thereto.

FIG. 11 is a skeleton explanatory view showing the relationship between the wire-guide member, mounted onto the guide rail, and a pressing arm (pressing member) of the wire-guide member.

FIG. 12 corresponds to FIG. 4 and shows another embodiment of a window regulator pertaining to the present invention.

FIG. 13 is cross-sectional view taken along the XIII-XIII line in FIG. 12.

### DESCRIPTION OF EMBODIMENTS

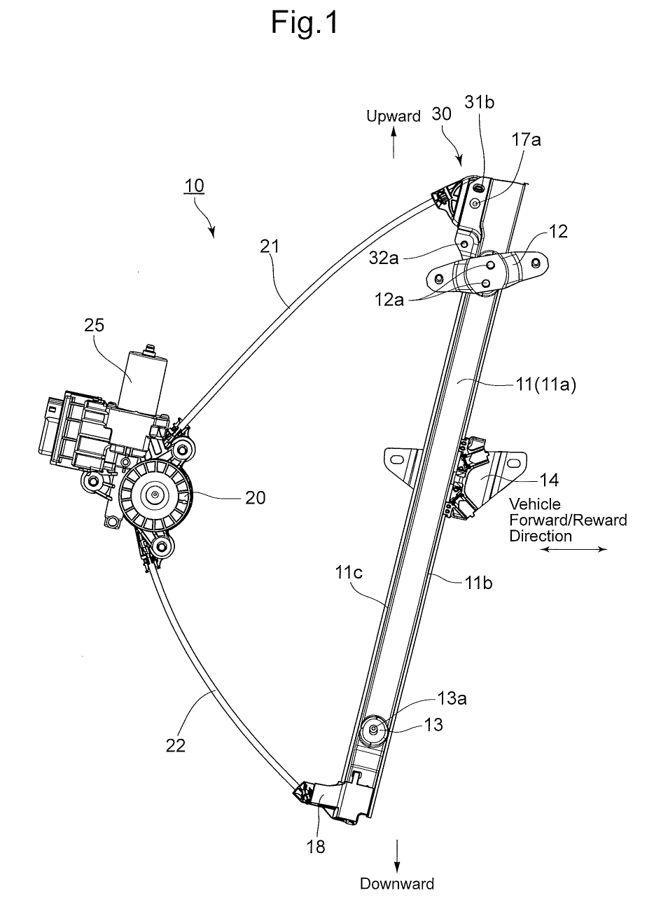

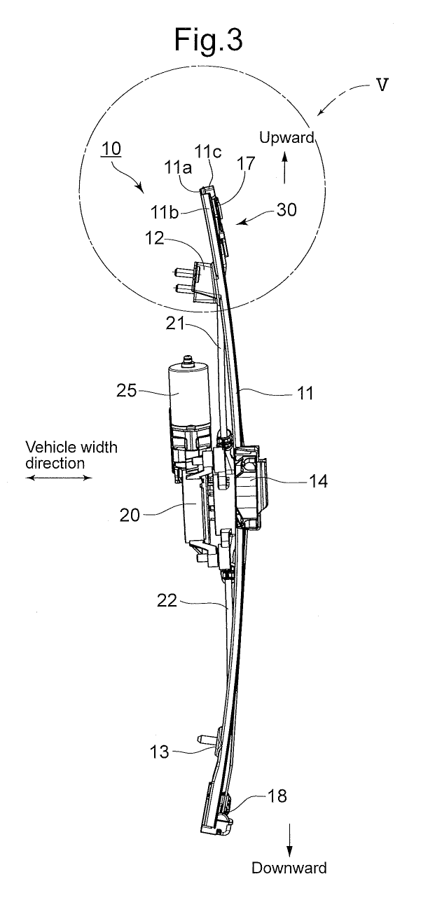

A window regulator 10 shown in FIGS. 1 through 3 raises and lowers a window glass (not shown) that is attached to the inner side of a door panel (not shown) of the vehicle. “Upward” and “Downward” indicated by arrows in FIGS. 1 through 3 correspond to the upward and downward directions of the vehicle.

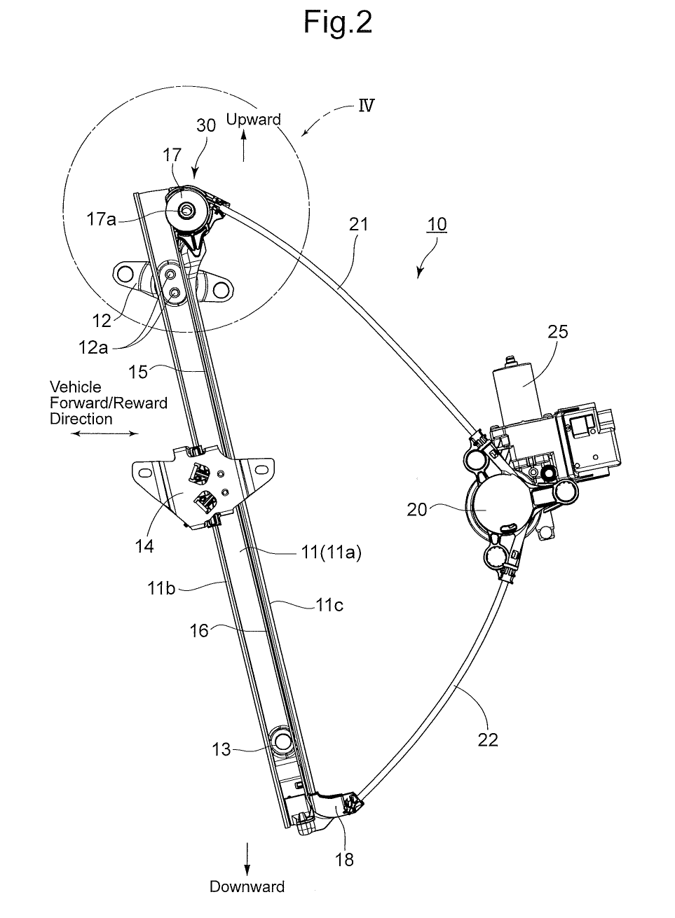

The window regulator 10 is provided with a guide rail 11, which is an elongated member, and the guide rail 11 is mounted to a door panel (inner panel) via mounting brackets 12 and 13 that are provided at different positions on the guide rail 11 with respect to the longitudinal direction of the guide rail 11. The mounting brackets (panel mounts) 12 and 13 are mounted onto the surface on the vehicle inner side of the guide rail 11 by burred portions 12a and 13a. A slider base 14, which supports a window glass, is supported to move along the longitudinal direction of the guide rail 11. Respective ends of a pair of drive wires 15 and 16 (FIG. 2) are connected to the slider base 14.

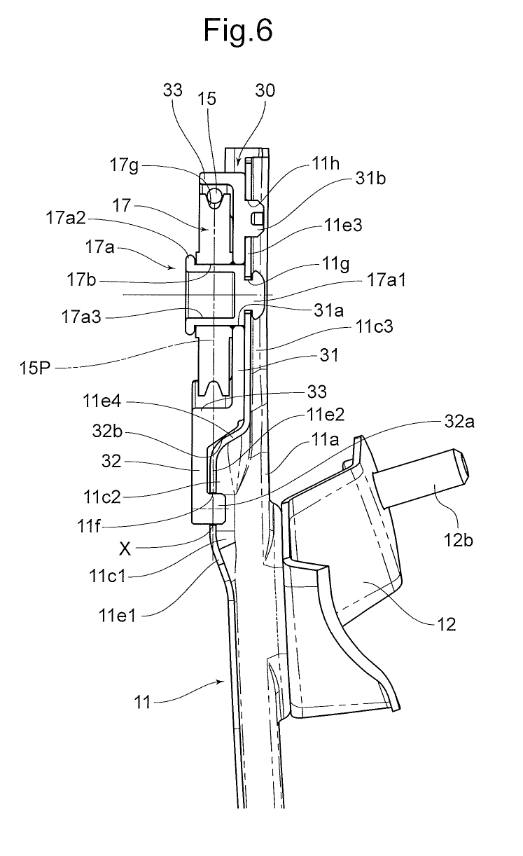

The drive wire 15 extends upwardly along the guide rail 11 from the slider base 14 and is guided by a guide pulley (wire guide) 17, which is provided at the close vicinity of the upper end of the guide rail 11 via a pulley bracket 30. The guide pulley 17 is rotatable about an axle pin (retainer pin) 17a, and the guide pulley 17 supports the drive wire 15 via a wire guide groove (winding part) 17g (see FIG. 6) formed on an outer peripheral surface thereof. The drive wire 16 extends downwardly along the guide rail 11 from the slider base 14 and is guided by a guide piece 18, which is provided at the close vicinity of the lower end of the guide rail 11. The guide piece 18 is fixed onto the guide rail 11, and the drive wire 16 is supported to advance and retreat along a wire guide groove (not shown) that is formed in the guide piece 18.

The drive wires 15 and 16 that exit from the guide pulley 17 and the guide piece 18 are inserted into guide tubes 21 and 22, and are wound around a wind-up drum (not shown) that is provided inside a drum housing 20, to which the guide tubes 21 and 22 are connected. The drum housing 20 is mounted to the door panel (inner door panel). The wind-up drum is rotatably driven by a drive motor (driver) 25. Upon the wind-up drum being forwardly/rearwardly rotated, one of the drive wires 15 and 16 increases its winding amount onto the wind-up drum (is wound onto the wind-up drum), and the other of the drive wires 15 and 16 is fed out from the wind-up drum, so that the slider base 14 moves along the guide rail 11 in accordance with the pulling and slackening relationship of the pair of drive wires 15 and 16. The window glass is raised and lowered in accordance with the movement of the slider base 14.

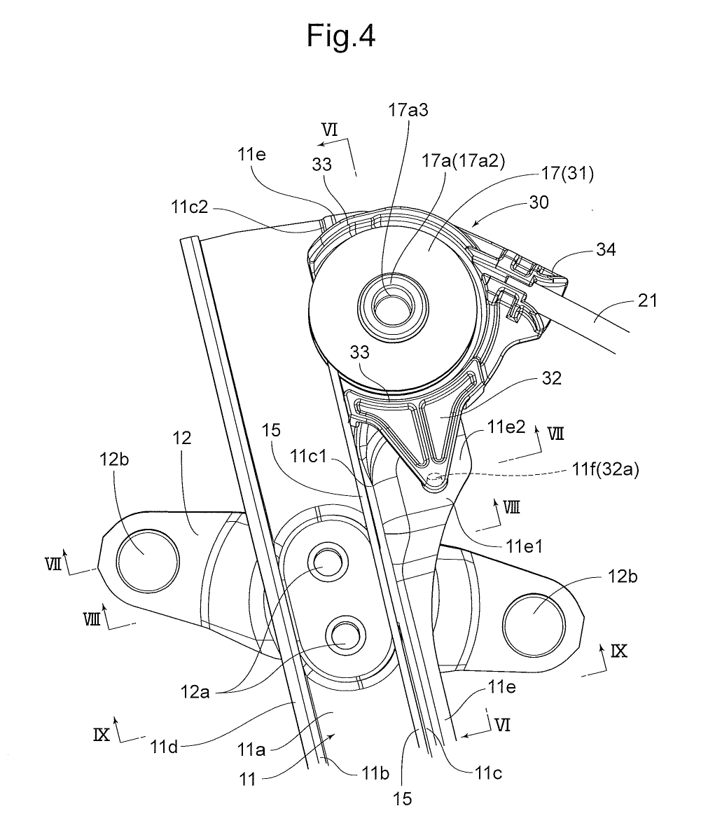

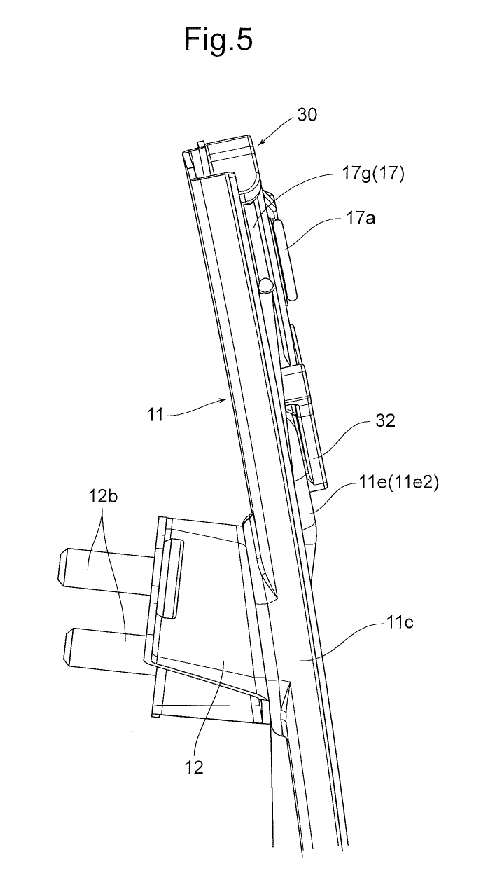

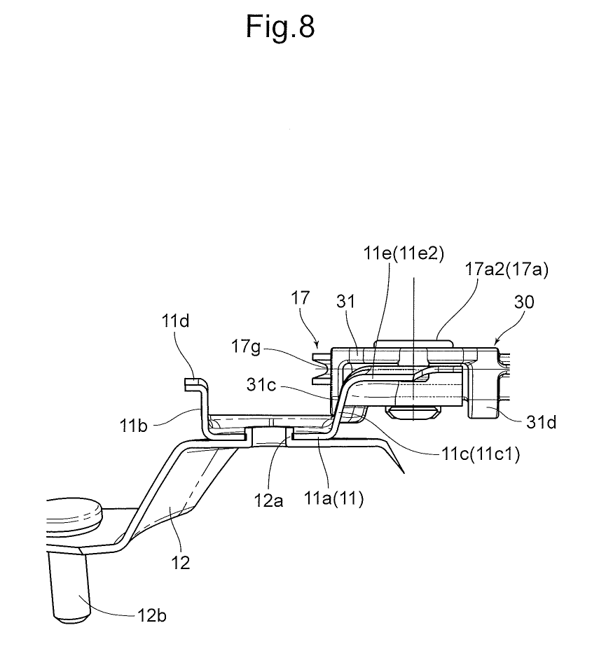

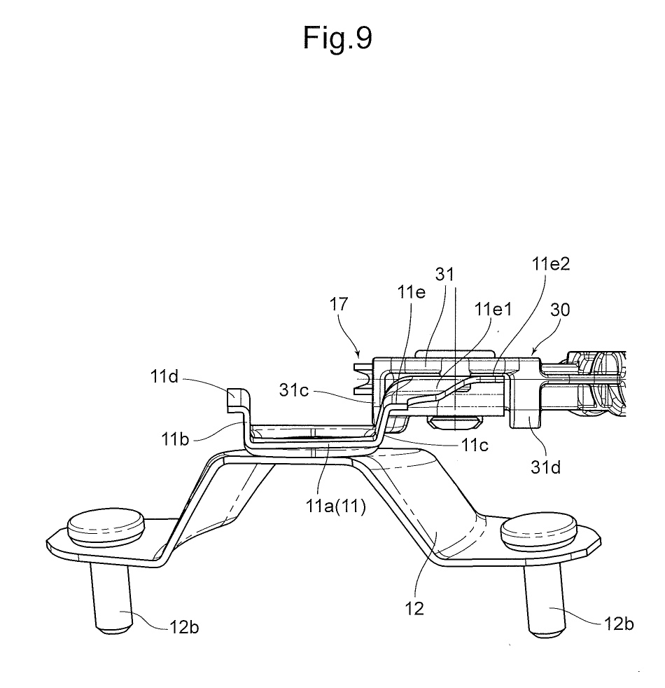

FIGS. 4 through 10 show a support structure around the guide pulley 17 at an upper end portion of the guide rail 11. As shown best in FIGS. 4 and 9, the general cross section, excluding the upper and lower end portions, of the guide rail 11 has a top hat cross section, provided with a base wall 11a, side walls 11b and 11c, and collar walls 11d and 11e which extend in outward directions from free edges of the side walls 11b and 11c. The side wall 11b is substantially orthogonal to the base wall 11a, whereas the side wall 11c is slightly opened out without being orthogonal to the base wall 11a.

Since the side wall 11c and the collar wall 11e of the guide rail 11 support the guide pulley 17 and the pulley bracket (wire guide) 30, the side wall 11c and the collar wall 11e have an irregular shape upward from the close vicinity of the mounting bracket 12. Namely, when the height direction is defined as a direction orthogonal to the base wall 11a, the side wall 11c is provided first with an inclined wall 11c1 (FIG. 6) having a smoothly-increasing height from the close vicinity of the mounting bracket 12, a high wall 11c2 (FIG. 6), and a pulley lead-in wall 11c3 (FIG. 6) which suddenly reduces in height from the high wall 11c2.

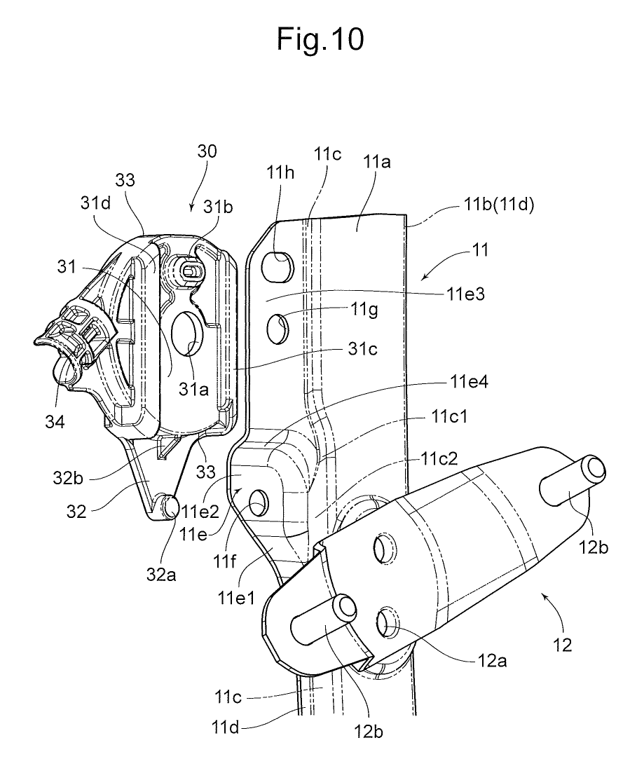

The collar wall 11e, which is communicably connected with an upper end (with respect to the height direction) of the inclined wall 11c1, is configured of a wide collar wall 11e2 via an increasingly-widening collar wall 11e1 (FIG. 4 and FIG. 10), which gradually increases in width (the length in the vehicle forward and rearward direction) in an upward direction from the close vicinity of the mounting bracket 12. A lock-engagement hole (pressing portion/offset supporter) 11f is formed at the vicinity of a boundary between the increasingly-widening collar wall 11e1 and the wide collar wall 11e2. The vicinity between the increasingly-widening collar wall 11e1 and the wide collar wall 11e2 is a part of the guide rail 11 that has the largest section coefficients (strengthened section-coefficient portion) with regard to the neutral axis in the vehicle forward and reward direction. Whereas, an upper end of the pulley lead-in wall 11c3, with respect to the height direction, is provided with a low collar wall 11e3, which is substantially parallel with the base wall 11a. The wide collar wall 11e2 and the low collar wall 11e3 are connected by an inclined wall 11e4 (FIG. 6 and FIG. 10). A pulley pin support hole (wire-guide retainer/mount) 11g and a pulley-bracket support hole (wire-guide retainer/mount) 11h are formed in the low collar wall 11e3.

As shown in the exploded perspective view, from the rear side, in FIG. 10, the pulley bracket 30, which is configured of a molded article of a synthetic resin material, is provided with a guide-pulley support wall 31, which is flat and circular in shape and has a linear cut-out portion at the base wall 11a side; a pressing arm (offset supporter/offset extension) 32 extending downwardly from the guide-pulley support wall 31; an eaves portion 33 positioned with respect to an upward and downward direction of the guide pulley 17; and a guide tube supporter 34. As shown in FIGS. 6 and 10, the eaves portion 33 is communicably connected with the pressing arm 32.

A pulley-pin insertion hole 31a (FIG. 6) is formed in a central portion of the guide-pulley support wall 31. Amount projection 31b (FIGS. 6 and 10), which fits into the pulley-bracket support hole 11h, is provided on a surface of the guide-pulley support wall 31 that faces toward the low collar wall 11e3. The pressing arm 32 has a substantially tapered triangular shape, in a plan view, and extends in a direction that is substantially parallel to an extending direction of the guide rail 11 from the pulley-pin insertion hole 31a. A lock-engaging projection 32a, which fits into the lock-engagement hole 11f, is formed on the end portion of the pressing arm 32. The engagement portion between the lock-engagement hole 11f and the lock-engaging projection 32a has a positional relationship so as to overlap with part of the mounting bracket 12, with respect to the upward and downward direction, when viewed in the vehicle forward and rearward direction. Furthermore, an inclined rib 32b, which abuts against an inclined wall 11e4 of the guide rail 11 is formed on the surface of the pressing arm 32 on the guide rail 11 side.

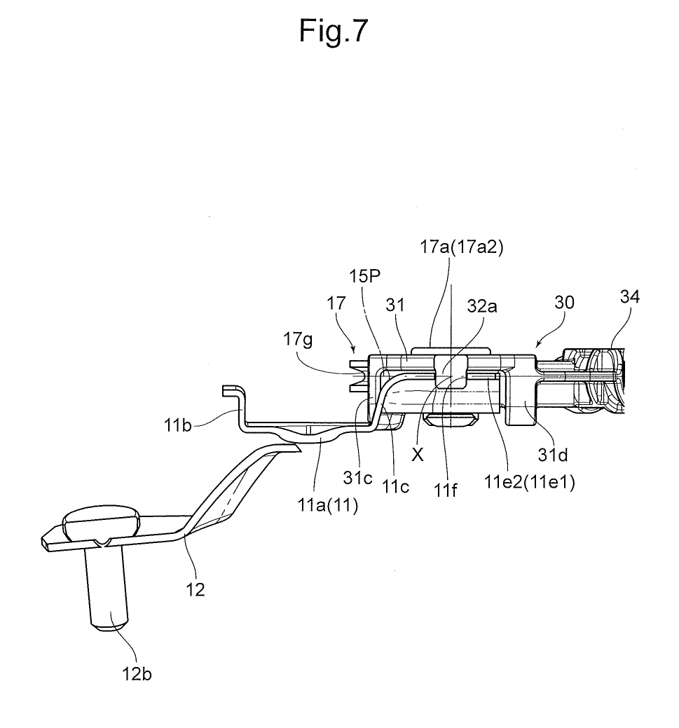

A plurality of reinforcement ribs 31c and 31d (FIGS. 7 through 10) are formed on an undersurface (the surface facing the low collar wall 11e3 side of the guide rail 11) of the guide-pulley support wall 31 of the pulley bracket 30. The plurality of reinforcement ribs 31c and 31d extend in an opposite direction to that of the eaves portion 33 from the guide-pulley support wall 31 and extend in the extending direction of the guide rail 11. The reinforcement rib 31c abuts against an inner surface of the side wall 11c of the guide rail 11, and the reinforcement rib 31d extends along the outer edge portion (the edge portion opposite to the side wall 11c) of the low collar wall 11e3 of the guide rail 11.

The pulley bracket 30 and the guide pulley 17 are supported by the low collar wall 11e3 of the guide rail 11 in the following manner. As shown best in FIG. 6, the metal axle pin 17a is inserted into an axle hole 17b of the guide pulley 17, and an small-diameter end portion 17a1 of the axle pin 17a is fitted into the pulley pin support hole 11g of the low collar wall 11e3. Simultaneously, the lock-engaging projection 32a of the pressing arm 32 is fitted into the lock-engagement hole 11f and the mount projection 31b is fitted into the pulley-bracket support hole 11h. The axle pin 17a is provided with a flange 17a2 on the opposite end of the axle pin 17a to the small-diameter end portion 17a1, and a bottomed hole 17a3 is formed into the axle portion of the axle pin 17a. The axle pin 17a is mounted onto the low collar wall 11e3, by clinching the head of the small-diameter end portion 17a1 in a state where a clinching jig is inserted into the bottomed hole 17a3, so that the guide pulley 17 is rotatably supported between the flange 17a2 of the axle pin 17a and the guide-pulley support wall 31 (and the small-diameter end portion 17a1 and the low collar wall 11e3), and the pulley bracket 30 is mounted onto the low collar wall 11e3. The mount projection 31b is thermobonded in a state where the mount projection 31b is fitted into the pulley-bracket support hole 11h. This mount projection 31b is also a mounting portion for mounting the pulley bracket 30 to the guide rail 11. The drive wire 15 is wound around the wind-up drum, provided inside the drum housing 20, after being wound onto the wire guide groove 17g on the peripheral surface of the guide pulley 17.

The above-described pulley bracket 30 is mounted to the low collar wall 11e3 (guide rail 11) at two positions, at the axle pin 17a and at the mount projection 31b (pulley-bracket support hole 11h). In this state, due to the lock-engaging projection 32a of the pressing arm 32 engaging with the lock-engagement hole 11f of the guide rail 11 (wide collar wall 11e2), deformation of the guide rail 11 when a downward tension is applied on the guide pulley 17 via the drive wire 15 can be suppressed. Since the mounting bracket 12 is mounted to the door panel via a mounting bolt 12b, this gives no opportunity for bowing deformation to occur, downward from the mounting bracket 12, in the guide rail 11; and since the engaging portion between the lock-engagement hole 11f of the guide rail 11 and the lock-engaging projection 32a of the pressing arm 32 has a positional relationship so as to overlap with part of the mounting bracket 12, with respect to the upward and downward direction, when viewed in the vehicle forward and rearward direction, the possibility of bowing deformation occurring in the guide rail 11 is further decreased. Furthermore, due to the inclined rib 32b abutting against the inclined wall 11e4, the combined section coefficients, with regard to the neutral axis in the vehicle forward and reward direction, of the guide rail 11 and the pulley bracket 30 increase, thereby suppressing deformation of the guide rail 11. Furthermore, the reinforcement ribs 31c and 31d which are formed on the underside of the guide-pulley support wall 31 also, and the same manner, suppress (bowing) deformation of the pulley bracket 30 itself and the bowing deformation of the guide rail 11.

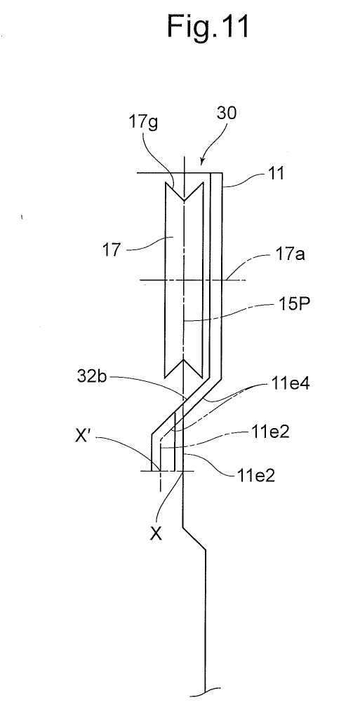

The deformation prevention effects of the guide rail 11 due to the engagement between the lock-engaging projection 32a and the lock-engagement hole 11f will be hereinafter explained. As shown in FIGS. 6 and 7, in the present embodiment, the engaging portion (pressing portion) X between the lock-engagement hole 11f and the lock-engaging projection 32a is located at an edge side of the guide rail 11 at which the guide pulley 17 is not present and is positioned on a plane 15P that includes the drive wire 15 that is wound onto the wire guide groove 17g of the guide pulley 17. In other words, the engaging portion (pressing portion) X between the lock-engagement hole 11f and the lock-engaging projection 32a is formed at a position that is offset, from the pulley pin support hole 11g and the pulley-bracket support hole (retainer) 11h, in a vehicle width direction toward the wire guide groove (winding part) 17g. Accordingly, even if the guide pulley 17 is pulled downwardly by tension applied on the drive wire 15, such force simply acts as a compression force in the upward and downward direction of (the wide collar wall 11e2 of) the guide rail 11, and does not cause bowing deformation. FIG. 11 is a skeleton view showing the positional relationship between the engagement portion X, of the lock-engaging projection 32a and the lock-engagement hole 11f, and the plane 15P including the drive wire 15. If an engaging portion X′, between the lock-engaging projection 32a and the lock-engagement hole 11f, is positioned (offset) from the plane 15P (including the drive wire 15) away from the mounting bracket 12, a force in an opposite direction of bowing deformation acts on (the wide collar wall 11e2 of) the guide rail 11, so that bowing deformation does not occur.

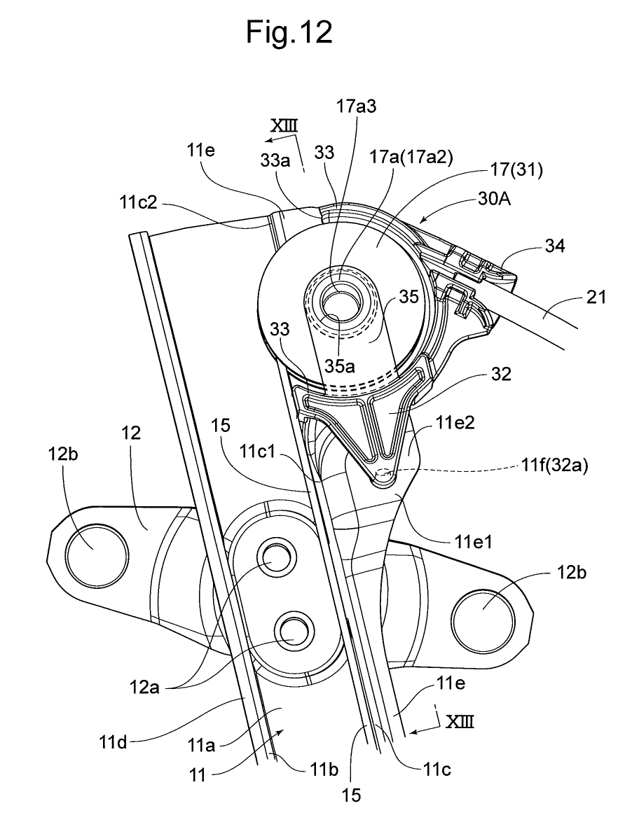

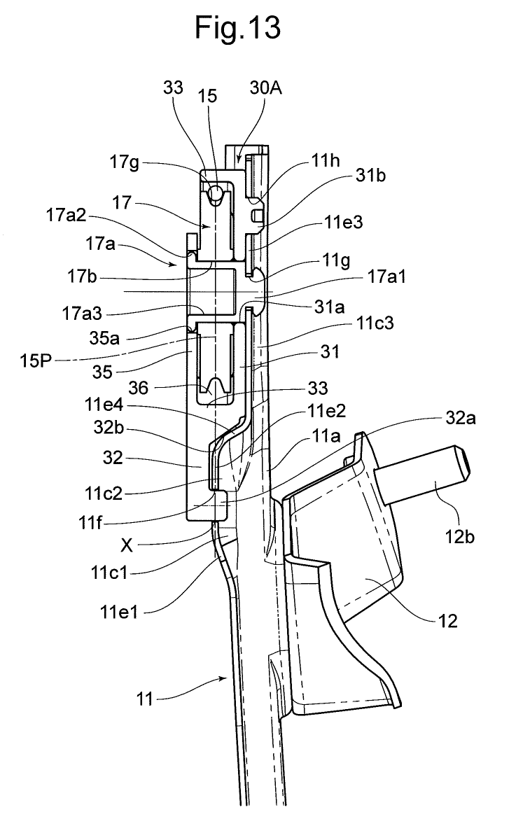

FIG. 12 and FIG. 13 show another embodiment of the window regulator, according to the present invention. FIG. 12 corresponds to FIG. 4, and FIG. 13 corresponds to FIG. 6. This embodiment is a modification of the shape of the pulley bracket 30A in which, in addition to the pulley bracket 30 of the above embodiment, a pulley-axle supporter (support wall) 35, which is integral with the pressing arm 32 and extends from downward to upward directions in FIGS. 12 and 13, is provided. The pulley-axle supporter 35 is parallel with the guide-pulley support wall 31 and forms an insertion space 36, for the guide pulley 17, between the pulley-axle supporter 35 and the guide-pulley support wall 31. An insertion support hole 35a for the axle pin 17a is formed in the end portion (the upper end in the drawing) of the pulley-axle supporter 35.

On the other hand, the pulley bracket 30A of this embodiment differs from the pulley bracket 30 of the above-described embodiment with respect to an eaves-cutout section 33a (FIG. 12), which is formed as a partial cutout from the eaves portion 33. The guide pulley 17 can be inserted into the insertion space 36 from the eaves-cutout section 33a. The other configurations of this embodiment are the same as the previous embodiment, and the same parts are designated by the same numerals.

In this embodiment, upon the axle pin 17a being inserted into the axle hole 17b of the guide pulley 17 (which is inserted into the insertion space 36 of the pulley bracket 30A) and the insertion support hole 35a of the pulley-axle supporter 35, the small-diameter end portion 17a1 being fitted into the pulley-pin insertion hole 31a and being fixedly clinched at the pulley pin support hole 11g of the guide rail 11, the flange 17a2 is fit-engaged into the insertion support hole 35a so that both ends of the axle pin 17a are supported by the pulley bracket 30A. Accordingly, the force applied on the guide pulley 17 via the drive wire 15 can be efficiently transferred to the guide rail 11 via the pressing arm 32.

The above descriptions are of embodiments in which the pulley bracket 30 having the guide pulley 17 is configured as a wire guide; however, the present invention can also be applied to a wire guide member (e.g., such as the guide piece 18 shown in FIGS. 1 and 2) that is not provided with a guide pulley.

The pressing arm 32 of the above embodiment has a substantially tapered triangular shape, in a plan view, and one lock-engaging projection 32a that fits into the lock-engagement hole 11f is formed on the end portion of the pressing arm 32; however, the pressing arm can be formed in a substantially rectangular shape. In such an embodiment, a pair of lock-engaging projections 32a may be provided at either corner of the rectangular pressing arm.

### INDUSTRIAL APPLICABILITY

The window regulator according to the present invention can be applied to vehicles in general, which have a window glass that is raised and lowered.

### REFERENCE SIGNS LIST

10 Window regulator

11 Guide rail

11a Base wall

11b, 11c Side walls

11c1 Inclined wall

11c2 High wall

11c3 Pulley lead-in wall

11d, 11e Collar walls

11e Collar wall

11e1 Increasingly-widening collar wall

11e2 Wide collar wall

11e3 Low collar wall

11e4 Inclined wall

11f Lock-engagement hole (pressing portion/hole)

11g Pulley pin support hole (wire-guide retainer)

11h Pulley-bracket support hole (wire-guide retainer)

12, 13 Mounting brackets (panel mounts)

12a Burred portion

12b Mounting bolt

14 Slider base

15, 16 drive wire

15P plane including drive wire

17 Guide pulley (pulley/wire guide)

17a Axle pin (pulley axle/retainer pin)

17a1 Small-diameter end portion

17a2 Flange

17a3 Bottomed hole

17b Axle hole

17g Wire guide groove (winding part)

21, 22 Guide tube

25 Drive motor (driver)

30, 30A Pulley bracket (wire guide)

31 Guide-pulley support wall

31a Pulley-pin insertion hole

31b Mount projection

31c, 31d Reinforcement ribs

32 Pressing arm

32a Lock-engaging projection (pressing portion/projection)

32b Inclined rib

33 Eaves portion

33a Eaves-cutout section

34 Guide tube supporter

35 Pulley-axle supporter (support wall)

35a Insertion support hole

36 Insertion space

X Engaging portion (pressing portion)

1. A window regulator for a vehicle comprising:
a guide rail extending in an upward and downward direction;
a slider base supported on the guide rail in a manner to be raisable and lowerable therealong, a window glass being mounted onto the slider base;
a drive wire connected to the slider base;
a wire guide supported at one end portion of the guide rail, the wire guide having a winding part onto which the drive wire is wound at a position offset from the guide rail in a vehicle width direction; and
a driver configured to raise and lower the slider base via the drive wire,
wherein the wire guide is supported by the guide rail by at least a retainer and a pressing portion, the retainer being engaged with the guide rail to prevent the wire guide from moving away from the guide rail in the vehicle width direction, and the pressing portion being engaged with the guide rail so as to press the guide rail toward the other end of the guide rail, and
wherein the pressing portion is formed at a position toward the other end relative to the retainer, and formed at a position that is offset from the retainer in the vehicle width direction toward the winding part.

2. The window regulator for a vehicle according to claim 1, wherein the pressing portion is positioned on a plane of movement in which the drive wire, which moves in accordance with the wire guide, or the pressing portion is positioned from the plane away from the retainer.

3. The window regulator for a vehicle according to claim 1, wherein the pressing portion overlaps with part of a panel mount, with respect to the upward and downward direction, when viewed in a vehicle forward and rearward direction, the panel mount configured to mount the guide rail to a door panel.

4. The window regulator for a vehicle according to claim 1, wherein the wire guide comprises:
a pulley bracket; and
a pulley, onto which the drive wire is wound, the pulley being rotatably supported by the pulley bracket,
wherein the retainer includes a pulley axle which supports the pulley and the pulley bracket onto the guide rail, and
wherein the pressing portion is formed on the pulley bracket.

5. The window regulator for a vehicle according to claim 4, wherein the pressing portion is connected to the pulley bracket,
wherein the pulley bracket is positioned to sandwich the pulley, in the vehicle width direction, by the retainer,
wherein the pulley bracket includes a pulley-axle supporter with which the pulley axle engages, and
wherein the pulley axle presses the pulley-axle supporter toward said other end.

6. The window regulator for a vehicle according to claim 1, wherein one of the pressing portions is a projection and the other of the pressing portions is a hole, into which said projection engages.
